(19) United States
(12) Patent Application Publication
(10) Pub. No.: US 2026/0142691 A1
(43) Pub. Date: May 21, 2026

(54) REFERENCE SIGNAL RECEIVED POWER BASED RECONFIGURABLE INTELLIGENT SURFACE CALIBRATION

(71) Applicant: QUALCOMM Incorporated, San Diego, CA (US)

(72) Inventors: Narayan PRASAD, Westfield, NJ (US); Tao LUO, San Diego, CA (US); Kobi RAVID, Closter, NJ (US); Junyi LI, Greentown, PA (US)

(21) Appl. No.: 18/955,390

(22) Filed: Nov. 21, 2024

(51) Int. Cl. H04B 7/04; H04B 17/318; H04L 5/00

(52) U.S. Cl. CPC H04B 7/04013; H04B 17/328; H04L 5/0005

(57) ABSTRACT

Various aspects of the present disclosure generally relate to wireless communication. In some aspects, a network node may transmit, to a reconfigurable intelligent surface (RIS), configuration information to configure the RIS to apply a set of RIS patterns associated with one or more calibration codebooks during an RIS calibration procedure. The network node may receive one or more reference signal received power (RSRP) measurement reports associated with one or more pilot signals that are transmitted during the RIS calibration procedure and while the RIS is applying the set of RIS patterns associated with the one or more calibration codebooks. The network node may update a data communication codebook based at least in part on the one or more RSRP measurement reports. Numerous other aspects are described.

### FIELD OF THE DISCLOSURE

Aspects of the present disclosure generally relate to wireless communication and specifically relate to techniques, apparatuses, and methods associated with reference signal received power based reconfigurable intelligent surface calibration.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### SUMMARY

In some aspects, a method of wireless communication performed by a network node includes transmitting, to a reconfigurable intelligent surface (RIS), configuration information to configure the RIS to apply a set of RIS patterns associated with one or more calibration codebooks during an RIS calibration procedure; receiving one or more reference signal received power (RSRP) measurement reports associated with one or more pilot signals that are transmitted during the RIS calibration procedure and while the RIS is applying the set of RIS patterns associated with the one or more calibration codebooks; and updating a data communication codebook based at least in part on the one or more RSRP measurement reports.

In some aspects, a method of wireless communication performed by an RIS includes receiving, from a network node, configuration information to configure the RIS to apply a set of RIS patterns associated with one or more calibration codebooks during an RIS calibration procedure; applying the set of RIS patterns during the RIS calibration procedure based at least in part on the configuration information; and receiving, from the network node, an indication of an updated data communication codebook, wherein the updated data communication codebook is based at least in part on one or more RSRP measurement reports associated with one or more pilot signals that are transmitted during the RIS calibration procedure and while the RIS is applying the set of RIS patterns associated with the one or more calibration codebooks.

In some aspects, a network node for wireless communication includes one or more memories; and one or more processors, coupled to the one or more memories, the one or more processors individually or collectively configured to cause the network node to: transmit, to an RIS, configuration information to configure the RIS to apply a set of RIS patterns associated with one or more calibration codebooks during an RIS calibration procedure; receive one or more RSRP measurement reports associated with one or more pilot signals that are transmitted during the RIS calibration procedure and while the RIS is applying the set of RIS patterns associated with the one or more calibration codebooks; and update a data communication codebook based at least in part on the one or more RSRP measurement reports.

In some aspects, an RIS for wireless communication includes one or more memories; and one or more processors, coupled to the one or more memories, the one or more processors individually or collectively configured to cause the RIS to: receive, from a network node, configuration information to configure the RIS to apply a set of RIS patterns associated with one or more calibration codebooks during an RIS calibration procedure; apply the set of RIS patterns during the RIS calibration procedure based at least in part on the configuration information; and receive, from the network node, an indication of an updated data communication codebook, wherein the updated data communication codebook is based at least in part on one or more RSRP measurement reports associated with one or more pilot signals that are transmitted during the RIS calibration procedure and while the RIS is applying the set of RIS patterns associated with the one or more calibration codebooks.

In some aspects, a non-transitory computer-readable medium storing a set of instructions for wireless communication includes one or more instructions that, when executed by one or more processors of a network node, cause the network node to: transmit, to an RIS, configuration information to configure the RIS to apply a set of RIS patterns associated with one or more calibration codebooks during an RIS calibration procedure; receive one or more RSRP measurement reports associated with one or more pilot signals that are transmitted during the RIS calibration procedure and while the RIS is applying the set of RIS patterns associated with the one or more calibration codebooks; and update a data communication codebook based at least in part on the one or more RSRP measurement reports.

In some aspects, a non-transitory computer-readable medium storing a set of instructions for wireless communication includes one or more instructions that, when executed by one or more processors of an RIS, cause the RIS to: receive, from a network node, configuration information to configure the RIS to apply a set of RIS patterns associated with one or more calibration codebooks during an RIS calibration procedure; apply the set of RIS patterns during the RIS calibration procedure based at least in part on the configuration information; and receive, from the network node, an indication of an updated data communication codebook, wherein the updated data communication codebook is based at least in part on one or more RSRP measurement reports associated with one or more pilot signals that are transmitted during the RIS calibration procedure and while the RIS is applying the set of RIS patterns associated with the one or more calibration codebooks.

In some aspects, an apparatus for wireless communication includes means for transmitting, to an RIS, configuration information to configure the RIS to apply a set of RIS patterns associated with one or more calibration codebooks during an RIS calibration procedure; means for receiving one or more RSRP measurement reports associated with one or more pilot signals that are transmitted during the RIS calibration procedure and while the RIS is applying the set of RIS patterns associated with the one or more calibration codebooks; and means for updating a data communication codebook based at least in part on the one or more RSRP measurement reports.

In some aspects, an apparatus for wireless communication includes means for receiving, from a network node, configuration information to configure the apparatus to apply a set of RIS patterns associated with one or more calibration codebooks during an RIS calibration procedure; means for applying the set of RIS patterns during the RIS calibration procedure based at least in part on the configuration information; and means for receiving, from the network node, an indication of an updated data communication codebook, wherein the updated data communication codebook is based at least in part on one or more RSRP measurement reports associated with one or more pilot signals that are transmitted during the RIS calibration procedure and while the RIS is applying the set of RIS patterns associated with the one or more calibration codebooks.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIG. 3 is a diagram illustrating an example of communications using a reconfigurable intelligent surface (RIS), in accordance with the present disclosure.

FIG. 4 is a diagram illustrating an example of communication links in a wireless network that includes an RIS, in accordance with the present disclosure.

FIG. 5 is a diagram illustrating an example of reference-signal-received-power-based RIS calibration, in accordance with the present disclosure.

FIG. 6 is a diagram illustrating an example process performed, for example, at a network node or an apparatus of a network node, in accordance with the present disclosure.

FIG. 7 is a diagram illustrating an example process performed, for example, at an RIS or an apparatus of an RIS, in accordance with the present disclosure.

FIG. 8 is a diagram of an example apparatus for wireless communication, in accordance with the present disclosure.

FIG. 9 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In wireless communication systems, such as 5G wireless communication systems, 6G wireless communication systems, or the like, one objective is to achieve ubiquitous coverage and connectivity. In this regard, technologies such as smart repeaters and reconfigurable intelligent surfaces (RISs) have emerged to enhance wireless network coverage, among other benefits. Smart repeaters (sometimes referred to as network-controlled repeaters), which may amplify signals received from a certain configured direction and/or may forward the signals in another configured direction, may be associated with relatively high costs and power consumption. RISs, on the other hand, which may include arrays of reflecting and/or refracting elements that can dynamically control the reflection and scattering of electromagnetic waves and/or refraction of electromagnetic waves, may pose a cost-effective alternative to smart repeaters.

In some examples, deployment of RISs in a wireless communication network may pose certain challenges. For example, the operational footprint of an RIS (e.g., the practical working area of an RIS and/or the effective operating range) may be restricted by a signal path loss experienced via reflection and/or refraction. Accordingly, to increase the operational footprint of certain RISs, relatively large apertures (e.g., the effective openings or areas of the RISs through which electromagnetic signals can be efficiently received and reflected and/or refracted) may be used, which generally involves using low-cost components to make RIS implementations financially viable. However, low-cost components may be susceptible to environmental variations and/or deformations (e.g., thermal-induced variations), resulting in phase-drifts over time. These phase-drifts may degrade the ability of the RIS to accurately reflect and/or refract signals towards intended directions, may impair system performance, and/or may necessitate frequent recalibrations of the RIS, among other examples, resulting in communication errors and thus high power, computing, and network resource consumption for correcting communication errors. Current techniques used to calibrate RIS elements may result in relatively poor calibration, due to poor signal strengths at buddy nodes (e.g., auxiliary wireless devices or network nodes that cooperate with the RIS to facilitate tasks such as calibration and/or that transmit and receive pilot signals during the RIS calibration procedure), uncoordinated calibration codebook designs, or uncertainty regarding buddy node locations during the calibration procedure, among other reasons.

Various aspects relate generally to improved calibration procedures of RISs within a wireless communication network. Some aspects more specifically relate to a network node transmitting configuration information to an RIS to configure the RIS (e.g., to configure a controller of the RIS) to implement RIS patterns in line with one or more calibration codebooks during an RIS calibration procedure. In some aspects, the network node may receive reference signal received power (RSRP) measurement reports associated with pilot signals that are transmitted during the RIS calibration procedure, and/or the network node may update data communication codebooks based at least in part on the RSRP measurement reports. In some aspects, the RIS patterns aid the network node in estimating phase-drift impairments of the RIS, such as by utilizing calibration techniques like grouping-based calibration codebook designs and/or dither-based calibration codebook designs, among other examples.

Particular aspects of the subject matter described in this disclosure can be implemented to realize one or more of the following potential advantages. In some examples, the described techniques can be used to facilitate enhanced phase-drift compensation during RIS calibration. For example, by updating the data communication codebook using RIS-specific RSRP reports, which reflect real-world environmental effects, and/or by accounting for the location uncertainty of network devices (e.g., buddy nodes), the methodology supports more precise RIS performance tuning. This may result in an improved calibration process by avoiding miscalculations in phase-drift estimations that can result in degraded signal quality or potential communications disruptions.

In this way, the described RIS calibration methods enable the conservation of network resources by reducing the need for frequent recalibration and/or by minimizing the data overhead required to handle communication inconsistencies. Additionally, by enabling more robust RIS calibration procedures and thus reduced communication errors, aspects and techniques described herein may conserve processing resources, memory resources, network resources, and/or the like, contributing to a more efficient operation of wireless communication networks (e.g., 5G wireless communication networks, 6G wireless communication networks, or the like). In this way, aspects described herein support more reliable and consistent network performance, therefore providing an infrastructural advantage in the deployment and optimization of advanced wireless communication systems.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

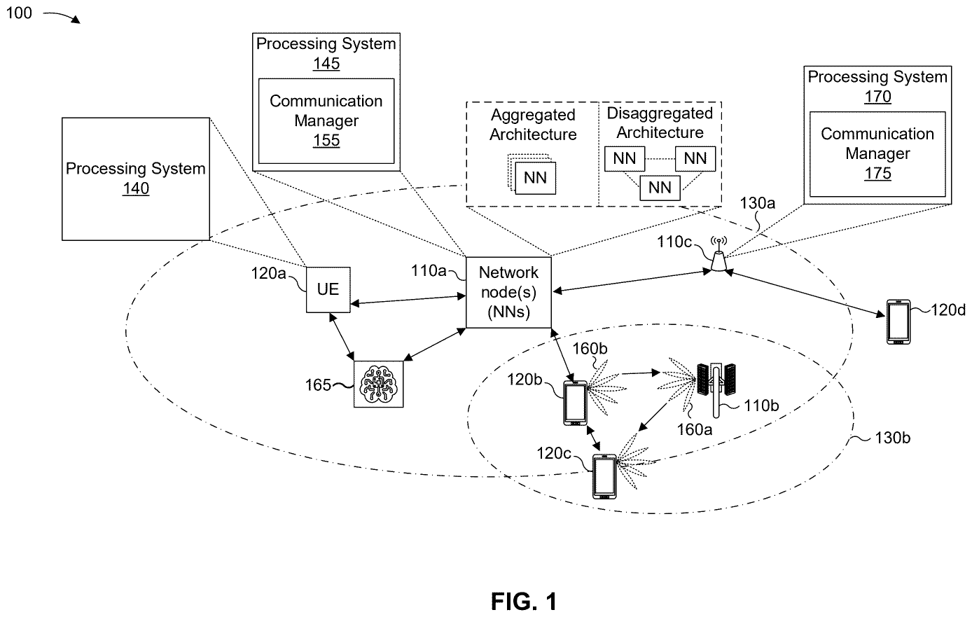

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a, network node 110b, and network node 110c. The network nodes 110 may support communications with multiple UEs 120. For example, in FIG. 1, the network nodes 110 support communication with a UE 120a, a UE 120b, a UE 120c, and a UE 120d. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

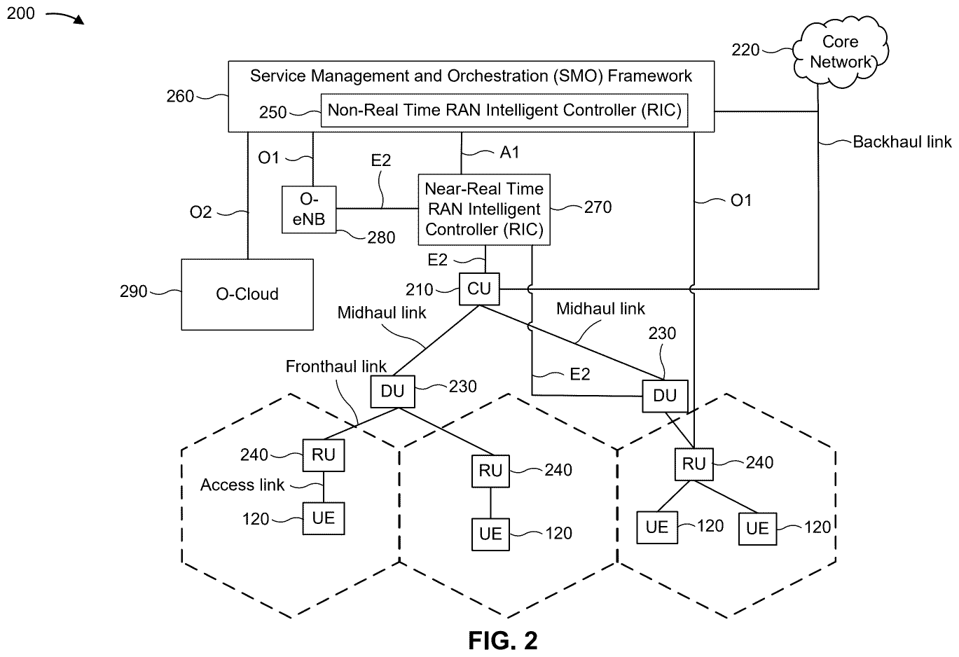

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot formal indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-RSRP parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, a network node 110 and/or UEs 120). For example, the one or more devices 165 may include a UE 120 (for example, the processing system 140), a network node 110 (for example, the processing system 145), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 120 and a second portion of the AI/ML model may be deployed at a network node 110). In other examples, a first AI/ML model may be deployed at a UE 120 and a second AI/ML model may be deployed at a network node 110. The AI/ML model(s) may be configured to enhance various aspects of the wireless communication network 100. For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110c (for example, a relay network node) may communicate with the network node 110a (for example, a macro network node) and the UE 120d in order to facilitate communication between the network node 110a and the UE 120d (for example, when the UE 120d is outside a coverage area of the cell 130a provided by the network node 110a and/or when an obstacle is between the network node 110a and the UE 120d, thereby blocking communications between the network node 110a and the UE 120d, among other examples). Additionally, or alternatively, a UE 120 may be or may operate as a relay that can relay transmissions to or from other UEs 120 or other wireless communication devices. A UE 120 that relays communications may be referred to as a UE relay or a relay UE, among other examples.

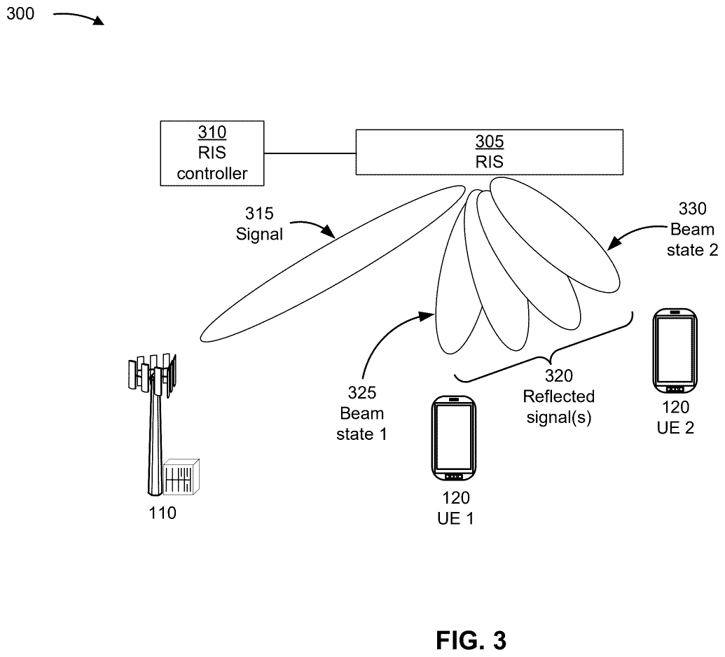

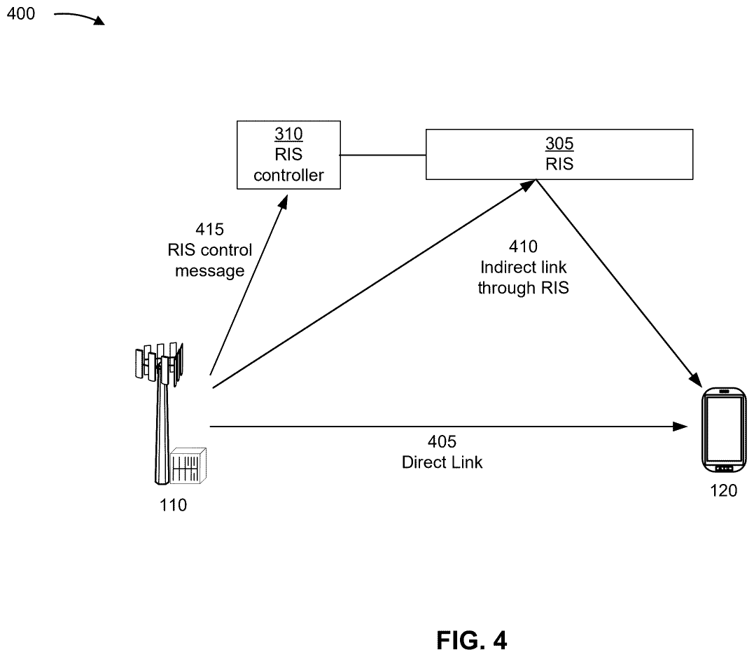

In some examples, a relay network node 110 may include an electromagnetic radiation reflective and/or refractive component that can be used to relay (for example, reflect and/or refract) signals from a first other network node 110 to a second other network node 110 or a UE 120. Such a relay network node 110 can include, for example, a radio frequency reflection array configured to perform radio frequency reflection functions and/or a radio frequency refractive array configured to perform radio frequency refraction functions. The electromagnetic radiation reflective array and/or refractive array can be, for example, an RIS (which also can be referred to as an intelligent reflective surface (IRS)). Aspects of an RIS are described in more detail below in connection with FIGS. 3-4.

In some aspects, the network node 110 may include a communication manager 155. As described in more detail elsewhere herein, the communication manager 155 may transmit, to an RIS, configuration information to configure the RIS to apply a set of RIS patterns associated with one or more calibration codebooks during an RIS calibration procedure; receive one or more RSRP measurement reports associated with one or more pilot signals that are transmitted during the RIS calibration procedure and while the RIS is applying the set of RIS patterns associated with the one or more calibration codebooks; and update a data communication codebook based at least in part on the one or more RSRP measurement reports. Additionally, or alternatively, the communication manager 155 may perform one or more other operations described herein.

In some aspects, an RIS (e.g., network node 110c) may include a processing system 170 (which may be similar to processing system 145) and/or a communication manager 175. As described in more detail elsewhere herein, the communication manager 175 may receive, from a network node, configuration information to configure the RIS to apply a set of RIS patterns associated with one or more calibration codebooks during an RIS calibration procedure; apply the set of RIS patterns during the RIS calibration procedure based at least in part on the configuration information; and receive, from the network node, an indication of an updated data communication codebook, wherein the updated data communication codebook is based at least in part on one or more RSRP measurement reports associated with one or more pilot signals that are transmitted during the RIS calibration procedure and while the RIS is applying the set of RIS patterns associated with the one or more calibration codebooks. Additionally, or alternatively, the communication manager 175 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

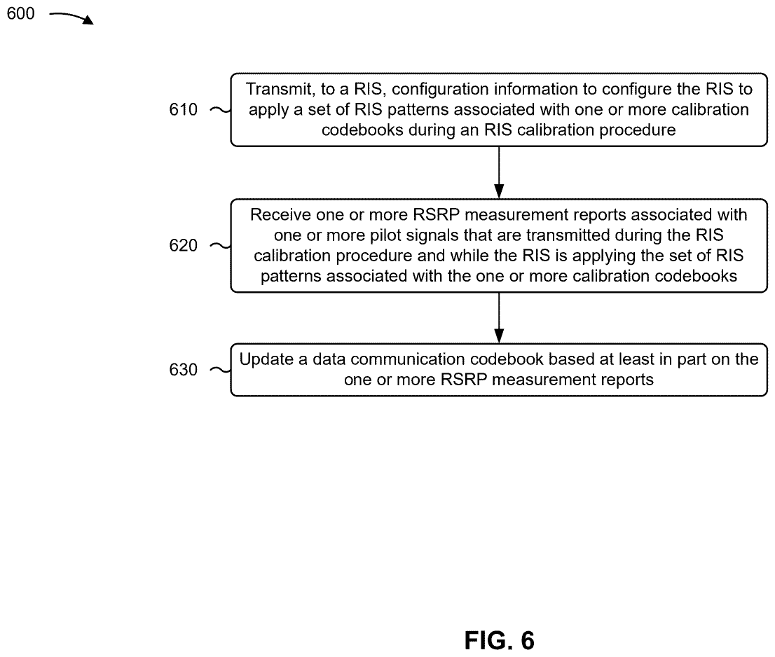

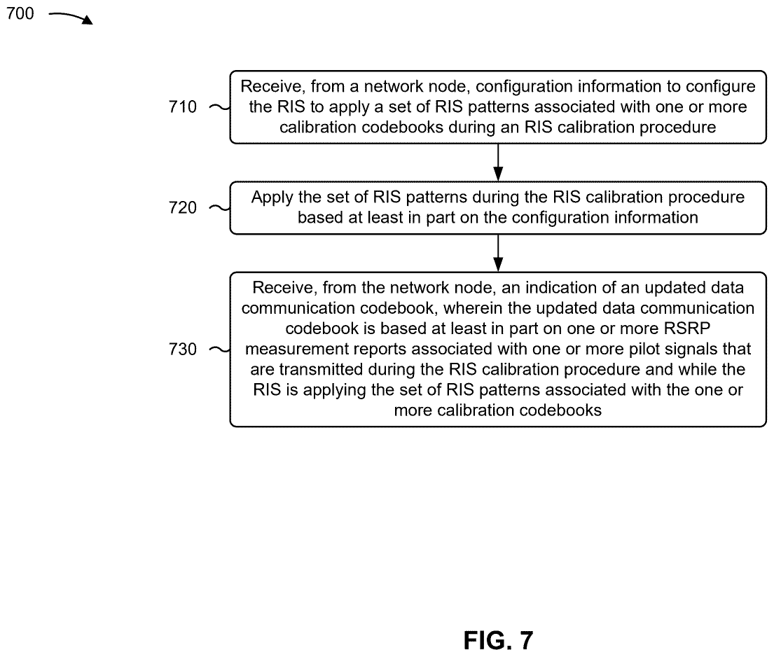

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with RSRP based RIS calibration, as described in more detail elsewhere herein. For example, the processing system 145 of the network node 110, the processing system 140 of the UE 120, the CU 210, the DU 230, or the RU 240 may perform or direct operations of, for example, process 600 of FIG. 6, process 700 of FIG. 7, or other processes as described herein (alone or in conjunction with one or more other processors). In some aspects, the RIS described herein is the network node 110, is included in the network node 110, or includes one or more components of the network node 110 shown in FIG. 1 (e.g., network node 110c shown in FIG. 1). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 600 of FIG. 6, process 700 of FIG. 7, or other processes as described herein. In some examples, executing instructions may include running the instructions, converting the instructions, compiling the instructions, and/or interpreting the instructions, among other examples.

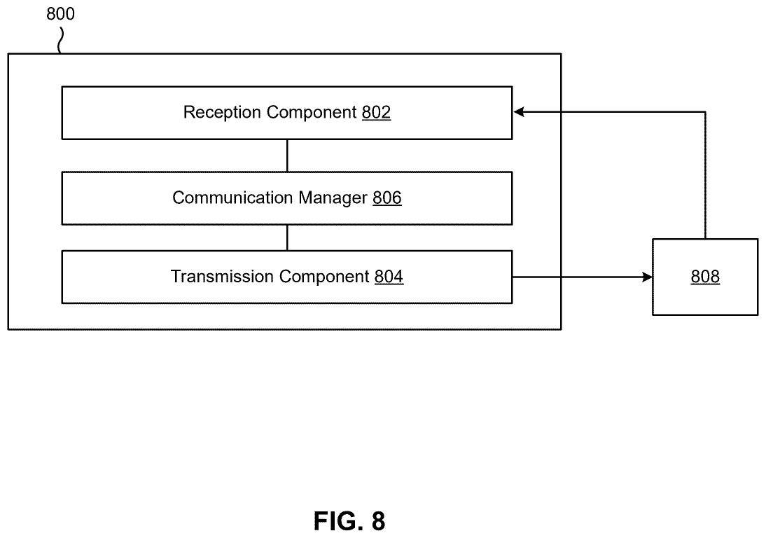

In some aspects, the network node 110 includes means for transmitting, to an RIS, configuration information to configure the RIS to apply a set of RIS patterns associated with one or more calibration codebooks during an RIS calibration procedure; means for receiving one or more RSRP measurement reports associated with one or more pilot signals that are transmitted during the RIS calibration procedure and while the RIS is applying the set of RIS patterns associated with the one or more calibration codebooks; and/or means for updating a data communication codebook based at least in part on the one or more RSRP measurement reports. The means for the network node 110 to perform operations described herein may include, for example, one or more of communication manager 155, processing system 145, a radio, one or more RF chains, one or more transceivers, one or more antennas, one or more modems, a reception component (for example, reception component 802 depicted and described in connection with FIG. 8), and/or a transmission component (for example, transmission component 804 depicted and described in connection with FIG. 8), among other examples. Additionally, or alternatively, the means for the network node 110 to perform the operations described herein may be an RU 240 and/or a component of the RU 240. For example, the RU 240 may transmit information (e.g., indications of one or more codebooks) to an RIS (e.g., network node 110c) and/or the RU 240 may transmit signals that can be relayed (e.g., reflected and/or refracted) by the RIS.

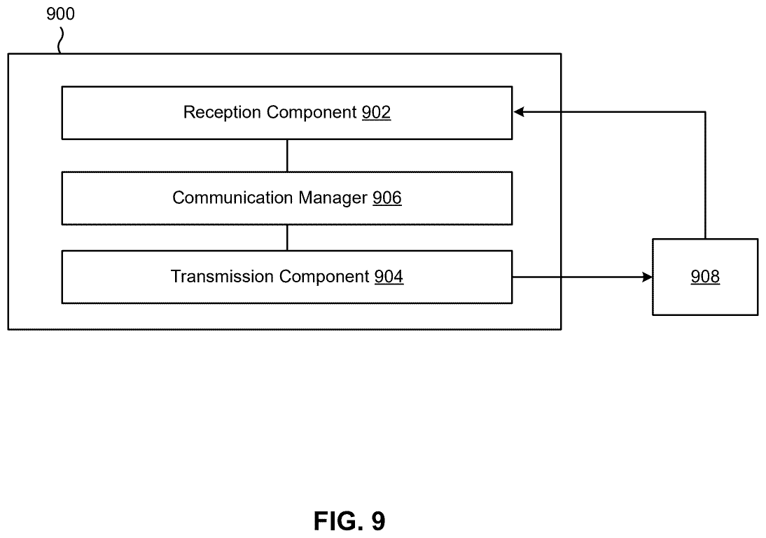

In some aspects, the RIS (e.g., network node 110c) includes means for receiving, from a network node, configuration information to configure the RIS to apply a set of RIS patterns associated with one or more calibration codebooks during an RIS calibration procedure; means for applying the set of RIS patterns during the RIS calibration procedure based at least in part on the configuration information; and/or means for receiving, from the network node, an indication of an updated data communication codebook, wherein the updated data communication codebook is based at least in part on one or more RSRP measurement reports associated with one or more pilot signals that are transmitted during the RIS calibration procedure and while the RIS is applying the set of RIS patterns associated with the one or more calibration codebooks. In some aspects, the means for the RIS to perform operations described herein may include, for example, one or more of communication manager 175, processing system 170, a radio, one or more RF chains, one or more transceivers, one or more antennas, one or more modems, a reception component (for example, reception component 902 depicted and described in connection with FIG. 9), and/or a transmission component (for example, transmission component 904 depicted and described in connection with FIG. 9), among other examples.

FIG. 3 is a diagram illustrating an example 300 of communications using an RIS, in accordance with the present disclosure. As shown in FIG. 3, a network node 110 may communicate with one or more UEs 120 in a wireless network, such as the wireless communication network 100. The network node 110 and the one or more UEs 120 may use an RIS 305 (e.g., network node 110c) to communicate with one another. For example, the RIS 305 may reflect, refract, and/or otherwise redirect a signal to the network node 110 and/or the one or more UEs 120. The RIS 305 may also be referred to as an intelligent reflecting surface. In some examples, the RIS 305 may be a repeater.

The RIS 305 may be, or may include, a planar or two-dimensional structure or surface that is designed to have properties to enable a dynamic control of signals or electromagnetic waves reflected, refracted, and/or redirected by the RIS 305. The RIS 305 may include one or more reconfigurable elements (sometimes referred to herein as one or more RIS elements). For example, the RIS 305 may include an array of RIS elements (e.g., an array of uniformly distributed reconfigurable elements). The RIS elements may be elements with a reconfigurable electromagnetic characteristic. For example, the electromagnetic characteristic may include a reflection characteristic (e.g., a reflection coefficient), a refraction characteristic (e.g., a refraction coefficient), a scattering characteristic, an absorption characteristic, and/or a diffraction characteristic. The electromagnetic characteristic(s) of each RIS element may be independently controlled and changed over time. The electromagnetic characteristic(s) of each RIS element may be independently configured such that the combination of configured states of the RIS elements reflects and/or refracts an incident signal or waveform in a controlled manner. For example, the RIS elements may be configured to reflect, refract, and/or redirect an impinging signal in a controlled manner, such as by reflecting and/or refracting the impinging signal in a desired direction, with a desired beam width, with a desired phase, with a desired amplitude, and/or with a desired polarization, among other examples. In other words, the RIS 305 may be capable of modifying one or more properties (e.g., direction, beam width, phase, amplitude, and/or polarization) of an impinging signal.

The RIS elements of the RIS 305 may be controlled and/or configured by an RIS controller 310. The RIS controller 310 may be a control module (e.g., a controller and/or a processor) that is capable of configuring the electromagnetic characteristic(s) of each RIS element of the RIS 305. The RIS controller 310 may be, or may be included in, the processing system 170 and/or the communication manager 175. Alternatively, the processing system 170 and/or the communication manager 175 may be included in the RIS controller 310. The RIS controller 310 may be associated with a modem and/or a similar component for purposes of communicating with a network node 110. The RIS controller 310 may receive control communications (e.g., from a network node 110 and/or a UE 120) indicating one or more properties of reflected and/or refracted signals (e.g., indicating a desired direction, a desired beam width, a desired phase, a desired amplitude, and/or a desired polarization). Therefore, in some examples, the RIS 305 may be capable of receiving communications (e.g., via the RIS 305 and/or the RIS controller 310). In some examples, the RIS 305 and/or the RIS controller 310 may not have transmit capabilities (e.g., the RIS 305 may be capable of reflecting, refracting, and/or redirecting impinging signals via the RIS elements, but may not be capable of generating and/or transmitting signals). Alternatively, in some examples, the RIS 305 and/or the RIS controller 310 may have transmit capabilities (e.g., the RIS 305 may be capable of reflecting, refracting, and/or redirecting impinging signals via the RIS elements and may be capable of generating and/or transmitting signals). For example, the RIS 305 and/or the RIS controller 310 may include one or more antennas and/or antenna elements for receiving and/or transmitting signals.

For example, as shown in FIG. 3, the network node 110 may transmit a signal 315. The signal 315 may be transmitted in a spatial direction toward the RIS 305. The RIS 305 may configure the RIS elements of the RIS 305 to reflect, refract, and/or redirect the signal 315 in a desired spatial direction and/or with one or more desired signal characteristics (e.g., beam width, phase, amplitude, frequency, and/or polarization). For example, as shown by reference number 320, the RIS 305 may be capable of reflecting the signal 315 in one or more spatial directions. Although multiple beams are shown in FIG. 3 representing different beam states or beam directions of the RIS 305, the RIS 305 may be capable of reflecting a signal with one beam state or one beam direction at a time. For example, in one case, as shown by reference number 325, the RIS 305 may be configured to reflect the signal 315 using a first beam state (e.g., beam state 1). “Beam state” may refer to a spatial direction and/or a beam of a reflected signal (e.g., a signal reflected by the RIS 305). The first beam state may cause the signal 315 to be reflected in a spatial direction toward a first UE 120 (e.g., UE 1). As shown by reference number 330, in another case, the RIS 305 may be configured to reflect the signal 315 using a second beam state (e.g., beam state 2). The second beam state may cause the signal 315 to be reflected in a spatial direction toward a second UE 120 (e.g., UE 2). In some other examples, the RIS 305 may be capable of refracting a signal in one or more spatial directions. In such examples, the RIS 305 (which may, in such examples, be referred to as a transmissive RIS) may redirect and/or change the beam width or phase of a signal while allowing the signal to pass through the RIS 305 and/or the RIS elements (e.g., rather than reflecting the signal off of the RIS 305 and/or the RIS elements). For example, in some examples, the RIS 305 may include may include one or more lenses (as examples of RIS elements) that are capable of modifying RF signals.

The RIS 305 may be deployed in a wireless network (such as the wireless communication network 100) to improve communication performance and efficiency. For example, the RIS 305 may enable a transmitter (e.g., a network node 110 or a UE 120) to control the scattering, reflection, and refraction characteristics of signals transmitted by the transmitter, to overcome the negative effects of wireless propagation. For example, the RIS 305 may effectively control signal characteristics (e.g., spatial direction, beam width, phase, amplitude, frequency, and/or polarization) of an impinging signal without a need for complex decoding, encoding, and radio frequency processing operations. Therefore, the RIS 305 may provide increased channel diversity for propagation of signals in a wireless network. The increased channel diversity provides robustness to channel fading and/or blocking, such as when higher frequencies are used by the network node 110 and/or the UE 120 (e.g., millimeter wave frequencies and/or sub-terahertz frequencies). Moreover, as the RIS 305 does not need to perform complex decoding, encoding, and radio frequency processing operations, the RIS 305 may provide a more cost and energy efficient manner of reflecting, refracting, and/or redirecting signals in a wireless network (e.g., as compared to other mechanisms for reflecting and/or redirecting signals, such as a relay device).

As indicated above, FIG. 3 is provided as an example. Other examples may differ from what is described with respect to FIG. 3.

FIG. 4 is a diagram illustrating an example 400 of communication links in a wireless network that includes an RIS, in accordance with the present disclosure. As shown, example 400 includes a network node 110, a UE 120, and the RIS 305. The RIS 305 may be controlled and/or configured by the RIS controller 310.

As shown in FIG. 4, the UE 120 may receive a communication (e.g., data and/or control information) directly from the network node 110 as a downlink communication. Additionally, or alternatively, the UE 120 may receive a communication (e.g., data and/or control information) indirectly from the network node 110 via the RIS 305. For example, the network node 110 may transmit the communication in a spatial direction toward the RIS 305, and the RIS 305 may redirect, refract, or reflect the communication to the UE 120.

In some examples, the UE 120 may communicate directly with the network node 110 via a direct link 405. For example, a communication may be transmitted via the direct link 405. A communication transmitted via the direct link 405 between the UE 120 and the network node 110 does not pass through and is not reflected, refracted, or redirected by the RIS 305. In some examples, the UE 120 may communicate indirectly with the network node 110 via an indirect link 410. For example, a communication may be transmitted via different segments of the indirect link 410. A communication transmitted via the indirect link 410 between the UE 120 and the network node 110 is reflected, refracted, and/or redirected by the RIS 305. As shown in FIG. 4 and by reference number 415, the network node 110 may communicate with the RIS 305 (e.g., with the RIS controller 310) via a control channel. For example, the network node 110 may indicate, in an RIS control message, spatial direction(s) and/or signal characteristics for signals reflected and/or refracted by the RIS 305. The RIS controller 310 may configure RIS elements of the RIS 305 in accordance with the RIS control message. In some examples, the RIS control message may indicate information associated with the wireless network, such as a frame structure, time synchronization information, and/or slot boundaries, among other examples. Using the communication scheme shown in FIG. 4 may improve network performance and increase reliability by providing the UE 120 with link diversity for communicating with the network node 110.

In some cases, the UE 120 may receive a communication (e.g., the same communication) from the network node 110 via both the direct link 405 and the indirect link 410. In other cases, the network node 110 may select one of the links (e.g., either the direct link 405 or the indirect link 410), and may transmit a communication to the UE 120 using only the selected link. Alternatively, the network node 110 may receive an indication of one of the links (e.g., either the direct link 405 or the indirect link 410), and may transmit a communication to the UE 120 using only the indicated link. The indication may be transmitted by the UE 120 and/or the RIS 305. In some examples, such selection and/or indication may be based at least in part on channel conditions and/or link reliability.

In some examples, phase-drifts at the RIS elements of the RIS 305 (e.g., unintentional, gradual, and often unpredictable variations in the phase of the reflected and/or refracted signals over time typically caused by environmental factors, such as thermal stress, component aging, and/or physical deformations of the RIS elements) may result in an RIS codebook becoming mismatched and/or an RIS 305 that does not reflect and/or refract signals in a desired direction. An RIS codebook (sometimes referred to herein as a data communication codebook) is a predefined set of configurations or patterns that dictate how the RIS elements of the RIS 305 adjust electromagnetic properties (e.g., phase shifts, reflection coefficients, and/or refraction coefficients) to achieve a desired signal transformation. In some examples, phase-drifts may creep due to environmental induced reasons, such as thermal stress and/or component changes, among other examples. Accordingly, in some examples an RIS 305 may need to be periodically recalibrated, such as for a purpose of compensating for phase-drifts at the RIS elements.

In some examples, an RIS calibration procedure may include a network node 110 identifying buddy nodes, such as a first TRP, UE 120, or other network entity to serve as a buddy transmitter and a second TRP, UE 120, or other network entity to serve as buddy receiver. The buddy transmitter may be configured to transmit pilot signals during the RIS calibration procedure and the buddy receiver may be configured to receive the reflected and/or refracted pilot signals from the RIS 305 and/or compute measurement reports (e.g., in-phase (I) component/quadrature (Q) component reports (I/Q reports)) during the RIS calibration procedure. More particularly, the buddy transmitter may transmit, to the RIS 305, the pilot signals in a buddy-transmitter-to-RIS channel g∈C^{N} (where C^{N} corresponds to an N-dimensional space of a complex numbers, and where N corresponds to the quantity of RIS elements at the RIS 305), and the RIS 305 may reflect and/or refract the pilot signals, to the buddy receiver, in an RIS-to-buddy-receiver channel h∈C^{N}. Moreover, the network node 110 may configure the RIS 305 (more particularly, the RIS controller 310) to apply RIS patterns from a calibration codebook Γₘ∈C^{N} during transmission and reception of the pilot signals by the buddy nodes, with the calibration codebook being a different codebook than the RIS codebook (e.g., the data communication codebook) described above. A cascade channel (e.g., a combined propagation path that includes the multiple segments of the communication link influenced by the RIS 305, such as the buddy-transmitter-to-RIS channel and the RIS-to-buddy-receiver channel) may thus be z=h⊙g∈C^{N}, which may be derived based on location for line-of-sight (LoS) links (e.g., direct propagation paths between the buddy transmitter and the RIS 305 and/or the RIS 305 and the buddy receiver).

In some examples, RIS calibration may be performed over M rounds (e.g., by transmitting M pilot signals, each reflected and/or refracted using a different RIS pattern, among other examples). In such examples, the m^{th} observation seen at the buddy receiver may be modeled as yₘ=(Γₘ)^{T}diag{e^{jφ}^{₁}, . . . , e^{jφ}^{_{N}}}z (with T being used to denote the matrix transpose operation), which is equivalent to yₘ=(Γₘ⊙z)^{T}x with x=[e^{jφ}^{₁}, . . . , e^{jφ}^{_{N}}]^{T} and with e^{jφ}^{₁}, . . . , e^{jφ}^{_{N}} corresponding to the N unknown phase-drifts. Accordingly, over M calibration rounds, the response seen at the buddy receiver may be y=Hx+η, where

$$H = [ \begin{matrix}{( {Γ}_{1} ⊙ z )}^{T} \\ ⋮ \\ {( {Γ}_{M} ⊙ z )}^{T}\end{matrix} ]$$

and where η corresponds to the noise in the cascade channel. Measurement reports (e.g., I/Q reports), determined by the buddy receiver, may be transmitted to the network node 110, and the network node 110 may determine phase-drifts and/or perform a deformation assessment, among other examples. More particularly, with knowledge of measurements at the buddy receiver (e.g., y), the calibration codebook patterns applied while the measurements were taken (e.g., Γₘ), and the cascade channel (e.g., z), the network node may be able to determine phase-drifts at the RIS 305, such as by solving the above equations for x, which corresponds to a vector of the phase-drifts as described above (e.g., x=[e^{jφ}^{₁}, . . . , e^{jφ}^{_{N}}]^{T}). The network node 110 may thus update a data communication codebook to accommodate for the phase-drifts and/or may transmit the updated data communication codebook to the RIS controller 310.

In some examples, the calibration codebooks may be associated with random RIS patterns. That is, during the RIS calibration procedure, the RIS controller 310 may be configured to use random RIS patterns. In such examples, entries of constituent codewords may be chosen randomly without using any information about buddy nodes, with each codeword essentially turning the RIS 305 into a diffuse scatterer. This may result in relatively poor measurement reports at the buddy receiver and/or little useful information to the network node 110 because a signal-to-noise ratio (SNR) at the buddy receiver may be relatively poor. Moreover, the RIS calibration procedure may be based on an assumption that the buddy nodes have phase coherency during the RIS calibration procedure (e.g., that there is consistency and alignment of the phase of signals received and transmitted by the buddy nodes involved in the RIS calibration process). Accordingly, for situations in which the buddy nodes do not have phase coherency during the entire RIS calibration procedure, the measurements may lead to erroneously calibrated data communication codebooks. Moreover, the RIS calibration procedure may be based on an assumption that the buddy nodes are stationary during the RIS calibration procedure. However, if one or more of the buddy nodes move during the RIS calibration procedure, such as in examples in which one or more of the buddy nodes are non-stationary UEs 120, the measurements may lead to erroneously calibrated data communication codebooks.

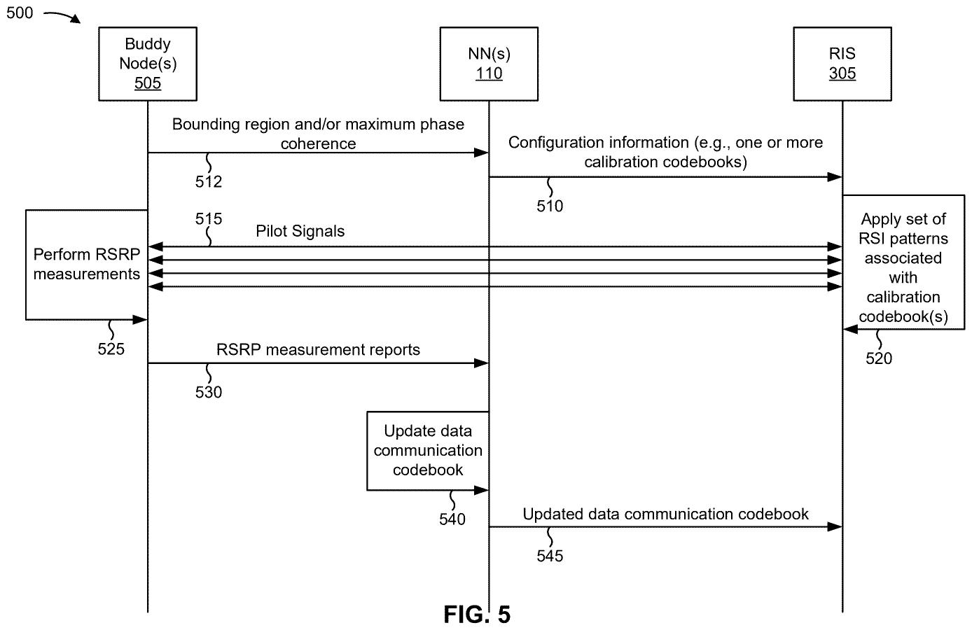

Accordingly, in some aspects described herein, an improved RIS calibration procedure may include use of certain calibration codebooks that enable increased phase coherency and/or SNR at the buddy nodes, indications and/or utilization of information associated with uncertainty of locations of one or more buddy nodes during the RIS calibration procedure, and/or signaling between the network node 110, RIS controller 310, and/or buddy nodes to enable the same. This may be more readily understood with reference to FIG. 5.

As indicated above, FIG. 4 is provided as an example. Other examples may differ from what is described with respect to FIG. 4.

FIG. 5 is a diagram illustrating an example 500 of RSRP-based RIS calibration, in accordance with the present disclosure. As shown in FIG. 5, a network node 110 (e.g., a CU, a DU, and/or an RU) may communicate with an RIS 305 (e.g., an RIS controller 310 of an RIS 305) and one or more buddy nodes 505 (e.g., one or more TRPs, one or more UEs 120, and/or one or more other network devices, which may include one or more buddy transmitters and one or more buddy receivers). In some aspects, the network node 110, the RIS 305, and the buddy nodes 505 may be part of a wireless network (e.g., wireless communication network 100). The network node 110, the RIS 305, and/or the buddy nodes 505 may have established wireless connections prior to operations shown in FIG. 5. For example, the network node 110 may have configured, prior to the operations shown in FIG. 5, the buddy nodes 505 to transmit and receive (via reflection and/or refraction by the RIS 305) one or more pilot signals (e.g., the pilot signals described below in connection with reference number 515) during an RIS calibration procedure.

As shown by reference number 510, the network node 110 may transmit, and the RIS 305 may receive, configuration information. In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may select a candidate configuration and/or communication parameter from the one or more candidate configurations and/or communication parameters.

In some aspects, the configuration information may configure the RIS 305 to apply a set of RIS patterns associated with one or more calibration codebooks during an RIS calibration procedure. In some aspects, the one or more calibration codebooks may be designed such that each calibration codeword (e.g., each RIS pattern) associated with the calibration codebook ensures good reflection and/or refraction by the RIS 305 of an incident signal from a buddy transmitter (as one example of a buddy node 505) to a buddy receiver (as another example of a buddy node 505) while ensuring that received observations at the buddy receiver are obtained from a sufficiently diverse set of RIS patterns (e.g., codewords) to ensure reliable estimation of phase-drifts using measurements such as RSRP reports. Put another way, the one or more calibration codebooks may be designed and/or selected in order to improve an SNR at the buddy receiver, as compared to RIS calibration procedures that use random RIS patterns (e.g., RIS calibration procedures in which constituent codewords are chosen randomly without using any information about buddy nodes), and/or to enable use of RSRP measurements for RIS calibration purposes.

In some aspects, the one or more calibration codebooks may be associated with a grouping-based calibration codebook design. The grouping-based calibration codebook design may be associated with grouping multiple RIS elements associated with the RIS into multiple groups, and, configuring RIS elements within each group with identical reflection coefficients and/or refraction coefficients. In such aspects, the use of different grouping patterns may be used to construct different calibration codewords that all generally point in the same reflection and/or refraction direction (e.g., toward the buddy receiver).

More particularly, the RIS 305 may be associated with a quantity of RIS elements in a horizontal direction, sometimes referred to as N_{X}, and a quantity of RIS elements in a horizontal direction, sometimes referred to as N_{Y}. In such aspects, the RIS elements of the RIS 305 may be grouped into groups having a size G_{X}×G_{Y}, where G_{X} corresponds to a quantity of RIS elements in each group in the horizontal direction (which may be less than N_{X}) and where G_{Y} corresponds to a quantity of RIS elements in each group in the vertical direction (which may be less than N_{Y}). In some aspects, each group includes adjacent RIS elements (e.g., the group of RIS elements may include a contiguous set of RIS elements such that each RIS element in the group has a shared boundary or edge with at least one other RIS element in the group). In such aspects, for a given cascade channel, z, the network node 110 may select, for use during the RIS calibration procedure, a calibration codeword Γ that optimizes received reflected and/or refracted signal power when all RIS elements in a group (e.g., in a G_{X}×G_{Y} group) are assigned an identical reflection coefficient and/or refraction coefficient. By adopting different grouping patterns, different calibration codewords may be constructed. Additionally, or alternatively, different grouping patterns may varyingly impact a reflected beam and/or a refracted beam at the RIS 305 and/or an ability to steer the reflected beams and/or refracted beams towards an estimated buddy receiver direction and/or location. Accordingly, the various RIS patterns may ensure a reflected beam and/or refracted beam approximately points towards the available buddy receive direction and/or location.

In some other aspects, the one or more calibration codebooks may be associated with a dither-based calibration codebook design. The dither-based calibration codebook design may be associated with a dither component used to introduce variability in reflected and/or refracted signal profiles. Put another way, the dither-based calibration codebook design may include RIS patterns that generally reflect and/or refract a signal toward the buddy receiver but which introduce disturbances (e.g., controlled perturbations) in the signal and/or RIS patterns, such as for a purpose of achieving variety in the observed signal useful for RIS calibration (e.g., such as for a purpose of generating diverse signal observations at the buddy receiver).

In some aspects, a dither-based calibration codebook design may be associated with a calibration codebook that has M=SN codewords (with S corresponding to a scaling factor), with each codeword having a length of N having entries from {±1, ±j}. In such aspects, an N-length dither, d, may be generated using a binary distribution on {1,j}, characterized by a probability p∈(0,1). Moreover, the dither, d, may be applied to the cascade channel estimate, z, to obtain dithered channel z⊙d. Additionally, a configuration, v, may be obtained by optimizing received reflected and/or refracted signal power for dithered channel, z⊙d, using a binary alphabet {±1}. In such aspects, a calibration codeword may be obtained as Γ=v⊙d. In this way, dither may be added to a channel while binary quantization may be used to steer the reflected and/or refracted beam toward the buddy receiver without undoing the dither, such as for a purpose of providing observational variety at the buddy receiver while ensuring high SNR for robust RSRP-based RIS calibration.

In some aspects, the one or more calibration codebooks described above may be based at least in part on a location uncertainty of the buddy nodes 505 during the RIS calibration procedure. For example, the network node 110 may determine a location uncertainty of the buddy nodes 505 during the RIS calibration procedure and/or may account for the location uncertainty (e.g., up to a specified and/or configured threshold) when selecting the one or more calibration codebooks and/or when estimating the phase-drifts associated with the RIS elements. In such aspects, the network node 110 may verify a strong LoS condition for a buddy-node-to-RIS link. A buddy node location uncertainty may then be translated into a buddy-node-to-RIS cascade channel uncertainty.

In some aspects, the buddy node location uncertainty may be associated with a bounding region associated with a buddy node, which may be a region surrounding the buddy node in which the buddy node is expected to be within during the RIS calibration procedure. In such aspects, the bounding region may be associated with a bounding cuboid or a bounding ellipsoid, among other examples. In some other aspects, the buddy node location uncertainty may be associated with a set of channel and/or steering-vector directions within a cone and/or a field of view.

In some aspects, a bounding region may be determined by a corresponding buddy node 505. In such aspects, and as indicated by reference number 512, one or more buddy nodes 505 may transmit, and the network node 110 may receive, an indication of one or more bounding regions associated with the one or more buddy nodes 505.

In some aspects, the network node 110 may select the one or more calibration codebooks based at least in part on at least one of a mutual-information (MI) maximization approach or a mean-squared-error (MSE) minimization approach. More particularly, as described above in connection with FIG. 4, over M calibration rounds, the response seen at the buddy receiver may be y=Hx+η, where

$$H = [ \begin{matrix}{( {Γ}_{1} ⊙ z )}^{T} \\ ⋮ \\ {( {Γ}_{M} ⊙ z )}^{T}\end{matrix} ]$$

and where η corresponds to the noise in the cascade channel. In some aspects, the network node 110 may select a calibration codebook using an MI maximization approach, such as by refining the calibration codebook according to the expression max_{{{r}_{ₘ}_{}}}{log|I+H*H|}. In some other examples, the network node 110 may select a calibration codebook using an MSE minimization approach, such as by refining the calibration codebook according to the expression min_{{{r}_{ₘ}_{}}}{tr((I+H*H)⁻¹)}. Additionally, or alternatively, in some aspects the network node 110 may select a calibration codebook based at least in part on a greedy approach. In a greedy approach, the network node 110 may start with a certain baseline calibration codebook (e.g., any of the calibration codebooks described herein), and may evaluate an impact of changing a coefficient assigned in round-p to element-q: (p,q). In such aspects, the network node 110 may select the best choice and/or iterate until no further improvement is possible.

In some aspects, in order to implement one of the MI maximization approach, the MSE minimization approach, and/or the greedy approach, the network node 110 may need to determine

$${( {( H + {ae}_{p} {e}_{q}^{T} )}^{*} ( H + {ae}_{p} {e}_{q}^{T} ) )}^{- 1} ,$$

where a is a scalar value, where eₘ is m^{th} unit-vector of length N, and where

$${( H + {ae}_{p} {e}_{q}^{T} )}^{*} ( H + {ae}_{p} {e}_{q}^{T} ) = {H}^{*} H + {\vert a \vert}^{2} {e}_{q} {e}_{q}^{T} + {H}^{*} {ae}_{p} {e}_{q}^{T} + \overline{a} {e}_{q}^{T} {e}_{p} H .$$

In some aspects, such as for a purpose of enabling implementation for larger examples, a current inverse (H*H)⁻¹ may be maintained and rank-1 inverse update formula may be used three times:

$${( A + {uv}^{T} )}^{- 1} = {A}^{- 1} - \frac{{A}^{- 1} {uv}^{T} {A}^{- 1}}{1 + {v}^{T} {A}^{- 1} u} .$$

In some aspects, the network node 110 may configure the RIS 305 to perform multiple (e.g., Q) calibration stages during the RIS calibration procedure, with a calibration codebook changing across the multiple calibration stages. In such aspects, the configuration information may configure the RIS 305 to apply a first calibration codebook during a first calibration stage of the Q calibration sounding stages, to apply a second calibration codebook during a second calibration stage of the Q calibration sounding stages, and so forth through a Q^{th} calibration stage.

In some aspects, a sequence of the calibration codebooks applied across the Q calibration stages may be responsive to a location uncertainty of the buddy nodes 505 during the RIS calibration procedure, a bounding region (e.g., a bounding box and/or ellipsoid) of the buddy nodes 505 during the RIS calibration procedure, and/or a cascade channel estimate (e.g., z) during the RIS calibration procedure, among other examples. For example, the configuration information may configure the RIS 305 to apply the one or more calibration codebooks according to a calibration codebook sequence, and the calibration codebook sequence may be based at least in part on respective bounding boxes associated with one or more buddy nodes 505, respective locations of the one or more buddy nodes 505, or respective cascade channel estimates associated with the one or more buddy nodes 505. In some aspects, at an end of the Q^{th} calibration stage, a final set of phase-drifts may be estimated by the network node 110 and/or RIS codebooks for assisting data-communications (e.g., one or more data communication codebooks) may be updated, which is described in more detail below in connection with reference number 540.

In some aspects, the network node 110 may configure the RIS 305 to perform the RIS calibration procedure using multiple buddy node pairs. In such aspects, the configuration information may configure the RIS 305 to apply a first calibration codebook during a first set of time-domain resources associated with transmission of a first pilot signal associated with a first buddy node pair, apply a second calibration codebook during a second set of time-domain resources associated with transmission of a second pilot signal associated with a second buddy node pair, and so forth. In some aspects, the network node 110 may configure the RIS 305 to perform the RIS calibration procedure using the multiple buddy node pairs in such a way that respective maximum phase-coherence limits (or coherence limits) are not exceeded for each buddy node pair. More particularly, the network node 110 may identify multiple buddy node pairs for calibration of the RIS. For each buddy node pair, the network node 110 may configure a respective calibration stage (e.g., time and/or frequency resources to be used to transmit and receive pilot signals) as well as a corresponding calibration codebook to be applied by the RIS 305 during the respective calibration stage. In some aspects, each calibration stage may adhere to a maximum coherence span (e.g., a maximum phase-coherence span) associated with the corresponding buddy node pair.

In such aspects, the network node 110 may receive an indication of the maximum coherence span associated with the various buddy nodes 505, such as via the communication indicated by reference number 512. In such aspects, for each buddy node pair, the network node 110 may receive an indication of a maximum coherence span associated with a first buddy node (e.g., a buddy transmitter) as well as an indication of a second maximum coherence span associated with a second buddy node (e.g., a buddy receiver). The network node 110 may identify a maximum coherence span associated with the buddy node pair, which may be a minimum of the first maximum coherence span and the second maximum coherence span. Moreover, the network node 110 may select a set of time-domain resources to be used by the buddy node pair during the RIS calibration procedure such that the duration of the set of time domain resources is less than or equal to the maximum coherence span associated with the buddy node pair.

For example, in some aspects the buddy nodes 505 may determine and/or indicate (e.g., via the signaling shown in connection with reference number 512) respective maximum phase-coherence spans based on the buddy nodes' respective capability and/or mobility status. A span for a certain buddy pair may be the minimum of the spans indicated by the two constituent nodes. In such aspects, within this span (which may be comprised of successive symbols or slots), the effective cascade channel for that buddy node pair may be assumed to be approximately constant. In such aspects, the network node 110 may configure multiple buddy node pairs to be used for the RIS calibration procedure, with each buddy node pair being configured to transmit and receive pilot signals during a period of time that is less than or equal to the determined span for that buddy node pair. In other aspects another maximum span can be indicated for the frequency domain such that for frequencies separated by an amount no greater than the indicated frequency domain span, the corresponding effective frequency domain cascade channels may be assumed to be approximately constant. In such aspects, the network node 110 may configure multiple buddy node pairs to be used for the RIS calibration procedure, with each buddy node pair being configured to transmit and receive pilot signals using a portion of bandwidth that is less than or equal to the determined frequency domain span for that buddy node pair.

As indicated by reference number 515, the buddy nodes 505 may transmit and receive one or more pilot signals during the RIS calibration procedure. More particularly, at least one buddy transmitter may transmit one or more pilot signals to at least one buddy receiver via the RIS 305 (e.g., by reflecting and/or refracting the signal via the RIS 305, as described above). In aspects in which the network node 110 configured multiple buddy node pairs to transmit pilot signals as described above, the pilot signals indicated by reference number 515 may be transmitted by respective buddy transmitters of the multiple buddy node pairs. More particularly, a first buddy node pair may transmit and receive a first set of pilot signals during a first time period (e.g., a first buddy transmitter of the first buddy node pair may transmit pilot signals during the first time period, and a first buddy receiver of the first buddy node pair may receive the pilot signals, after reflection and/or refraction by the RIS 305, during the first time period), a second buddy node pair may transmit and receive a second set of pilot signals during a second time period (e.g., a second buddy transmitter of the second buddy node pair may transmit pilot signals during the second time period, and a second buddy receiver of the second buddy node pair may receive the pilot signals, after reflection and/or refraction by the RIS 305, during the second time period), and so forth.

As indicated by reference number 520, while the buddy nodes 505 are transmitting and receiving pilot signals, the RIS 305 may apply a set of RIS patterns associated with the one or more calibration codebooks (e.g., the one or more calibration codebooks configured by the configuration information described above in connection with reference number 510). In some aspects, applying the set of RIS patterns associated with the one or more calibration codebooks may include applying RIS patterns associated with multiple calibration stages, as described above. Additionally, or alternatively, applying the set of RIS patterns associated with the one or more calibration codebooks may include applying calibration codebooks associated with multiple buddy node pairs, as described above.

Moreover, as indicated by reference number 525, during the RIS calibration procedure (e.g., during transmission of the pilot signals that are reflected and/or refracted by the RIS 305 while applying the set of RIS patterns associated with the one or more calibration codebooks), the buddy nodes 505 (more particularly, the buddy receivers) may perform signal strength measurements, such as RSRP measurements. That is, the buddy nodes 505 (e.g., the buddy receivers) may perform RSRP measurements of the pilot signals received (e.g., by the buddy receivers) after being reflected and/or refracted by the RIS 305. In some aspects, performing RSRP measurements and/or calibrating data communication codebooks based on RSRP measurements may be more practical (e.g., may consume less processing resources, among other examples) as compared to traditional calibration methods that may be based on complex I/Q reports.

As indicated by reference number 530, the buddy nodes 505 (more particularly, the one or more buddy receivers) may transmit, and the network node 110 may receive, one or more RSRP measurement reports associated with one or more pilot signals. Put another way, the buddy nodes 505 (more particularly, the one or more buddy receivers) may transmit, and the network node 110 may receive, RSRP measurement reports indicating the RSRP measurements performed during the RIS calibration procedure (e.g., performed while the pilot signals are transmitted and received and while the RIS 305 is applying the set of RIS patterns associated with the one or more calibration codebooks).

As indicated by reference number 540, the network node 110 may update a data communication codebook based at least in part on the one or more RSRP measurement reports. In some aspects, updating the data communication codebook may include estimating phase-drift impairments (e.g., phase-drifts) of the RIS 305 based at least in part on the one or more RSRP measurement reports and/or updating the data communication codebook based at least in part on the estimated phase-drifts. Put another way, if the network node 110 determines that estimated phase-drifts have degraded below a threshold, the network node 110 may identify that the data communication codebook should be updated and/or may update the data communication codebook to compensate for the phase-drifts. In aspects in which the RIS calibration procedure includes multiple calibration stages (e.g., Q calibration stages, as described above), at an end of the Q^{th} calibration stage, the final set of phase-drifts may be estimated based on RSRP measurements performed during the Q calibration stages, and the data communication codebook may be updated accordingly. Additionally, or alternatively, in aspects in which the buddy nodes 505 include multiple buddy node pairs, the network node 110 may use RSRP measurement reports from different buddy node pairs to determine RIS 305 phase-drifts. In such aspects, diversity over the multiple buddy channels may assist a structured calibration codebook design more than a random calibration codebook design.

In some aspects, the network node 110 may update the data communication codebook based at least in part on a bounding region (e.g., a bounding cuboid or a bounding ellipsoid, as described above) associated with a location uncertainty of at least one buddy node. For example, in aspects in which the buddy nodes 505 indicate bounding regions to the network node 110 (as described above in connection with reference number 512) or in which the network node 110 otherwise determines bounding regions associated with the buddy nodes 505, the network node 110 may determine phase-drifts of the RIS 305 and/or update a data communication codebook based at least in part on treating a calibration and/or phase-drift estimation problem as a constrained least-squares problem associated with the following expressions:

$${min}_{\begin{matrix}x , z , v : \\ x = [ {e}^{j {ϕ}_{1}} , ... ... {e}^{j {ϕ}_{N}} ] \\ {ϕ}_{n} ∈ [ 0 , 2 π ) ∀ n \\ z ∈ C , v = [ {e}^{j {α}_{1}} , .. , {e}^{j {α}_{M}} ] , {α}_{q} ∈ [ 0 , 2 π ) ∀ q\end{matrix}} {‖ \vert y \vert ⊙ v - Hx ‖}^{2} .$$

As indicated by reference number 545, the network node 110 may transmit, and the RIS 305 may receive, the updated data communication codebook. As described above, in some aspects, the updated data communication codebook may be based at least in part on the one or more RSRP measurement reports associated with one or more pilot signals that are transmitted during the RIS calibration procedure and while the RIS 305 is applying the set of RIS patterns associated with the one or more calibration codebooks. That is, the updated data communication codebook may be a data communication codebook that accounts for estimated phase-drifts by the various RIS elements that are determined by the network node 110 using the one or more RSRP measurement reports, as described above. In this way, the network node 110 may ensure that the data communication codebook remains optimized under varying conditions and uncertainties associated with the use and performance of the RIS 305.

Based at least in part on the network node 110 configuring the RIS 305 to apply RIS patterns associated with one or more calibration codebooks during an RIS calibration procedure and/or the network node 110 updating a data communication codebook based at least in part on RSRP measurements performed during the RIS calibration procedure, the RIS 305 and/or the network node 110 may conserve computing, power, network, and/or communication resources that may have otherwise been consumed by traditional RIS calibration procedures. For example, based at least in part on the network node 110 configuring the RIS 305 to apply RIS patterns associated with one or more calibration codebooks during an RIS calibration procedure and/or the network node 110 updating a data communication codebook based at least in part on RSRP measurements performed during the RIS calibration procedure, more accurate phase-drift estimations may be performed and/or accounted for, resulting in RIS-based communications (in which RIS uses codewords or patterns from the updated data communications codebook to reflect and/or refract signals for data communications) that exhibit a reduced error rate, which may conserve computing, power, network, and/or communication resources that may have otherwise been consumed to detect and/or correct communication errors.

As indicated above, FIG. 5 is provided as an example. Other examples may differ from what is described with regard to FIG. 5.

FIG. 6 is a diagram illustrating an example process 600 performed, for example, at a network node or an apparatus of a network node, in accordance with the present disclosure. Example process 600 is an example where the apparatus or the network node (e.g., network node 110) performs operations associated with RSRP based RIS calibration.

As shown in FIG. 6, in some aspects, process 600 may include transmitting, to an RIS, configuration information to configure the RIS to apply a set of RIS patterns associated with one or more calibration codebooks during an RIS calibration procedure (block 610). For example, the network node (e.g., using transmission component 804 and/or communication manager 806, depicted in FIG. 8) may transmit, to an RIS, configuration information to configure the RIS to apply a set of RIS patterns associated with one or more calibration codebooks during an RIS calibration procedure, as described above.

As further shown in FIG. 6, in some aspects, process 600 may include receiving one or more RSRP measurement reports associated with one or more pilot signals that are transmitted during the RIS calibration procedure and while the RIS is applying the set of RIS patterns associated with the one or more calibration codebooks (block 620). For example, the network node (e.g., using reception component 802 and/or communication manager 806, depicted in FIG. 8) may receive one or more RSRP measurement reports associated with one or more pilot signals that are transmitted during the RIS calibration procedure and while the RIS is applying the set of RIS patterns associated with the one or more calibration codebooks, as described above.

As further shown in FIG. 6, in some aspects, process 600 may include updating a data communication codebook based at least in part on the one or more RSRP measurement reports (block 630). For example, the network node (e.g., using communication manager 806, depicted in FIG. 8) may update a data communication codebook based at least in part on the one or more RSRP measurement reports, as described above.

Process 600 may include additional aspects, such as any single aspect or any combination of aspects described below and/or in connection with one or more other processes described elsewhere herein.

In a first aspect, the set of RIS patterns associated with the one or more calibration codebooks is configured to enable estimation of phase-drift impairments of the RIS based at least in part on the one or more RSRP measurement reports.

In a second aspect, alone or in combination with the first aspect, the RIS is associated with multiple RIS elements, the one or more calibration codebooks are associated with a grouping-based calibration codebook design, the grouping-based calibration codebook design is associated with grouping the multiple RIS elements into multiple groups, and, for each group, of the multiple groups, the respective RIS elements are configured with identical reflection coefficients.

In a third aspect, alone or in combination with one or more of the first and second aspects, the one or more calibration codebooks are associated with a dither-based calibration codebook design, and the dither-based calibration codebook design is associated with a dither component used to introduce variability in reflected signal profiles.

In a fourth aspect, alone or in combination with one or more of the first through third aspects, the one or more pilot signals are transmitted, during the RIS calibration procedure, from a first buddy node to a second buddy node via the RIS, process 600 further includes identifying a bounding region associated with a location uncertainty of at least one of the first buddy node or the second buddy node, and updating the data communication codebook is further based at least in part on the bounding region.

In a fifth aspect, alone or in combination with one or more of the first through fourth aspects, the bounding region is associated with one of a bounding cuboid or a bounding ellipsoid.

In a sixth aspect, alone or in combination with one or more of the first through fifth aspects, process 600 includes receiving, from at least one of the first buddy node or the second buddy node, an indication of the bounding region.

In a seventh aspect, alone or in combination with one or more of the first through sixth aspects, process 600 includes selecting the one or more calibration codebooks based at least in part on at least one of a mutual-information maximation approach or a mean-squared-error minimization approach.

In an eighth aspect, alone or in combination with one or more of the first through seventh aspects, the RIS calibration procedure is associated with multiple calibration sounding stages, the configuration information configures the RIS to apply a first calibration codebook, of the one or more calibration codebooks, during a first calibration stage, of the multiple calibration sounding stages, and the configuration information configures the RIS to apply a second calibration codebook, of the one or more calibration codebooks, during a second calibration stage, of the multiple calibration sounding stages.

In a ninth aspect, alone or in combination with one or more of the first through eighth aspects, the configuration information configures the RIS to apply the one or more calibration codebooks according to a calibration codebook sequence, and the calibration codebook sequence is based at least in part on respective bounding boxes associated with one or more buddy nodes, respective locations of the one or more buddy nodes, or respective cascade channel estimates associated with the one or more buddy nodes.

In a tenth aspect, alone or in combination with one or more of the first through ninth aspects, the RIS calibration procedure is associated with multiple buddy node pairs, the configuration information configures the RIS to apply a first calibration codebook, of the one or more calibration codebooks, during a first set of time-domain resources associated with transmission of a first pilot signal associated with a first buddy node pair, of the multiple buddy node pairs, and the configuration information configures the RIS to apply a second calibration codebook, of the one or more calibration codebooks, during a second set of time-domain resources associated with transmission of a second pilot signal associated with a second buddy node pair, of the multiple buddy node pairs.

In an eleventh aspect, alone or in combination with one or more of the first through tenth aspects, process 600 includes receiving, from a first buddy node associated with the first buddy node pair, an indication of a first maximum coherence span associated with the first buddy node, receiving, from a second buddy node associated with the first buddy node pair, an indication of a second maximum coherence span associated with the second buddy node, identifying a maximum coherence span associated with the first buddy node pair, wherein maximum coherence span associated with the first buddy node pair corresponds to a minimum of the first maximum coherence span and the second maximum coherence span, and selecting the first set of time-domain resources such that a duration of the first set of time-domain resources is less than or equal to the maximum coherence span associated with the first buddy node pair.

In a twelfth aspect, alone or in combination with one or more of the first through eleventh aspects, process 600 includes identifying a maximum frequency-domain coherence span associated with the first buddy node pair, and selecting a set of frequency-domain resources associated with the first set of time-domain resources such that a bandwidth associated with the set of frequency-domain resources is less than or equal to the maximum frequency-domain coherence span associated with the first buddy node pair.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, at an RIS or an apparatus of an RIS, in accordance with the present disclosure. Example process 700 is an example where the apparatus or the RIS (e.g., RIS 305) performs operations associated with RSRP based RIS calibration.

As shown in FIG. 7, in some aspects, process 700 may include receiving, from a network node, configuration information to configure the RIS to apply a set of RIS patterns associated with one or more calibration codebooks during an RIS calibration procedure (block 710). For example, the RIS (e.g., using reception component 902 and/or communication manager 906, depicted in FIG. 9) may receive, from a network node, configuration information to configure the RIS to apply a set of RIS patterns associated with one or more calibration codebooks during an RIS calibration procedure, as described above.

As further shown in FIG. 7, in some aspects, process 700 may include applying the set of RIS patterns during the RIS calibration procedure based at least in part on the configuration information (block 720). For example, the RIS (e.g., using communication manager 906, depicted in FIG. 9) may apply the set of RIS patterns during the RIS calibration procedure based at least in part on the configuration information, as described above.

As further shown in FIG. 7, in some aspects, process 700 may include receiving, from the network node, an indication of an updated data communication codebook, wherein the updated data communication codebook is based at least in part on one or more RSRP measurement reports associated with one or more pilot signals that are transmitted during the RIS calibration procedure and while the RIS is applying the set of RIS patterns associated with the one or more calibration codebooks (block 730). For example, the RIS (e.g., using reception component 902 and/or communication manager 906, depicted in FIG. 9) may receive, from the network node, an indication of an updated data communication codebook, wherein the updated data communication codebook is based at least in part on one or more RSRP measurement reports associated with one or more pilot signals that are transmitted during the RIS calibration procedure and while the RIS is applying the set of RIS patterns associated with the one or more calibration codebooks, as described above.

Process 700 may include additional aspects, such as any single aspect or any combination of aspects described below and/or in connection with one or more other processes described elsewhere herein.

In a first aspect, the set of RIS patterns associated with the one or more calibration codebooks is configured to enable estimation of phase-drift impairments of the RIS based at least in part on the one or more RSRP measurement reports.

In a second aspect, alone or in combination with the first aspect, the RIS is associated with multiple RIS elements, the one or more calibration codebooks are associated with a grouping-based calibration codebook design, the grouping-based calibration codebook design is associated with grouping the multiple RIS elements into multiple groups, and, for each group, of the multiple groups, the respective RIS elements are configured with identical reflection coefficients.

In a third aspect, alone or in combination with one or more of the first and second aspects, the one or more calibration codebooks are associated with a dither-based calibration codebook design, and the dither-based calibration codebook design is associated with a dither component used to introduce variability in reflected signal profiles.

In a fourth aspect, alone or in combination with one or more of the first through third aspects, the one or more pilot signals are transmitted, during the RIS calibration procedure, from a first buddy node to a second buddy node via the RIS, and the updated data communication codebook is further based at least in part on a bounding region associated with a location uncertainty of at least one of the first buddy node or the second buddy node.

In a fifth aspect, alone or in combination with one or more of the first through fourth aspects, the bounding region is associated with one of a bounding cuboid or a bounding ellipsoid.

In a sixth aspect, alone or in combination with one or more of the first through fifth aspects, the one or more calibration codebooks are selected based at least in part on at least one of a mutual-information maximation approach or a mean-squared-error minimization approach.

In a seventh aspect, alone or in combination with one or more of the first through sixth aspects, the RIS calibration procedure is associated with multiple calibration sounding stages, applying the set of RIS patterns comprises applying a first calibration codebook, of the one or more calibration codebooks, during a first calibration stage, of the multiple calibration sounding stages, and applying a second calibration codebook, of the one or more calibration codebooks, during a second calibration stage, of the multiple calibration sounding stages.

In an eighth aspect, alone or in combination with one or more of the first through seventh aspects, the configuration information configures the RIS to apply the one or more calibration codebooks according to a calibration codebook sequence, and the calibration codebook sequence is based at least in part on respective bounding boxes associated with one or more buddy nodes, respective locations of the one or more buddy nodes, or respective cascade channel estimates associated with the one or more buddy nodes.

In a ninth aspect, alone or in combination with one or more of the first through eighth aspects, the RIS calibration procedure is associated with multiple buddy node pairs, and process 700 further includes applying a first calibration codebook, of the one or more calibration codebooks, during a first set of time-domain resources associated with transmission of a first pilot signal associated with a first buddy node pair, of the multiple buddy node pairs, and applying a second calibration codebook, of the one or more calibration codebooks, during a second set of time-domain resources associated with transmission of a second pilot signal associated with a second buddy node pair, of the multiple buddy node pairs.

In a tenth aspect, alone or in combination with one or more of the first through ninth aspects, a first duration of the first set of time-domain resources is less than or equal to a first maximum coherence span associated with the first buddy node pair, and a second duration of the second set of time-domain resources is less than or equal to a second maximum coherence span associated with the second buddy node pair.

In an eleventh aspect, alone or in combination with one or more of the first through tenth aspects, a first bandwidth of a first set of frequency-domain resources associated with the first set of time-domain resources is less than or equal to a first maximum frequency-domain coherence span associated with the first buddy node pair, and a second bandwidth of a second set of frequency-domain resources associated with the second set of time-domain resources is less than or equal to a second maximum frequency-domain coherence span associated with the second buddy node pair.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication, in accordance with the present disclosure. The apparatus 800 may be a network node, or a network node may include the apparatus 800. In some aspects, the apparatus 800 includes a reception component 802, a transmission component 804, and/or a communication manager 806, which may be in communication with one another (for example, via one or more buses and/or one or more other components). In some aspects, the communication manager 806 is the communication manager 155 described in connection with FIG. 1. As shown, the apparatus 800 may communicate with another apparatus 808, such as a UE or a network node (such as a CU, a DU, an RU, or a base station), using the reception component 802 and the transmission component 804. The communication manager 806 may be included in, or implemented via, a processing system (for example, the processing system 145 described in connection with FIG. 1) of the network node.

In some aspects, the apparatus 800 may be configured to perform one or more operations described herein in connection with FIG. 5. Additionally, or alternatively, the apparatus 800 may be configured to perform one or more processes described herein, such as process 600 of FIG. 6. In some aspects, the apparatus 800 and/or one or more components shown in FIG. 8 may include one or more components of the network node described in connection with FIG. 1. Additionally, or alternatively, one or more components shown in FIG. 8 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications, and may provide the processed signals to the one or more other components of the apparatus 800. In some aspects, the reception component 802 may include one or more components of the network node described above in connection with FIG. 1, such as a radio, one or more RF chains, one or more transceivers, or one or more modems, each of which may in turn be coupled with one or more antennas of the network node. In some aspects, the reception component 802 and/or the transmission component 804 may include or may be included in a network interface. The network interface may be configured to obtain and/or output signals for the apparatus 800 via one or more communications links, such as a backhaul link, a midhaul link, and/or a fronthaul link.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications, and may transmit the processed signals to the apparatus 808. In some aspects, the transmission component 804 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 804 may be co-located with the reception component 802.

The communication manager 806 may support operations of the reception component 802 and/or the transmission component 804. For example, the communication manager 806 may receive information associated with configuring reception of communications by the reception component 802 and/or transmission of communications by the transmission component 804. Additionally, or alternatively, the communication manager 806 may generate and/or provide control information to the reception component 802 and/or the transmission component 804 to control reception and/or transmission of communications.

The transmission component 804 may transmit, to an RIS, configuration information to configure the RIS to apply a set of RIS patterns associated with one or more calibration codebooks during an RIS calibration procedure. The reception component 802 may receive one or more RSRP measurement reports associated with one or more pilot signals that are transmitted during the RIS calibration procedure and while the RIS is applying the set of RIS patterns associated with the one or more calibration codebooks. The communication manager 806 may update a data communication codebook based at least in part on the one or more RSRP measurement reports.

The reception component 802 may receive, from at least one of a first buddy node or a second buddy node, an indication of the bounding region.

The communication manager 806 may select the one or more calibration codebooks based at least in part on at least one of a mutual-information maximation approach or a mean-squared-error minimization approach.

The reception component 802 may receive, from a first buddy node associated with the first buddy node pair, an indication of a first maximum coherence span associated with the first buddy node.

The reception component 802 may receive, from a second buddy node associated with the first buddy node pair, an indication of a second maximum coherence span associated with the second buddy node.

The communication manager 806 may identify a maximum coherence span associated with the first buddy node pair, wherein maximum coherence span associated with the first buddy node pair corresponds to a minimum of the first maximum coherence span and the second maximum coherence span.

The communication manager 806 may select a first set of time-domain resources such that a duration of the first set of time-domain resources is less than or equal to the maximum coherence span associated with the first buddy node pair.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram of an example apparatus 900 for wireless communication, in accordance with the present disclosure. The apparatus 900 may be an RIS, or an RIS may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 175 described in connection with FIG. 1. As shown, the apparatus 900 may communicate with another apparatus 908, such as a UE or a network node (such as a CU, a DU, an RU, or a base station), using the reception component 902 and the transmission component 904. The communication manager 906 may be included in, or implemented via, a processing system (for example, the processing system 170 described in connection with FIG. 1) of the RIS.

In some aspects, the apparatus 900 may be configured to perform one or more operations described herein in connection with FIG. 5. Additionally, or alternatively, the apparatus 900 may be configured to perform one or more processes described herein, such as process 700 of FIG. 7. In some aspects, the apparatus 900 and/or one or more components shown in FIG. 9 may include one or more components of the network node 110c described in connection with FIG. 1. Additionally, or alternatively, one or more components shown in FIG. 9 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components of the network node 110c described above in connection with FIG. 1, such as a radio, one or more RF chains, one or more transceivers, or one or more modems, each of which may in turn be coupled with one or more antennas of the network node 110c. In some aspects, the reception component 902 may be associated with RIS elements (e.g., reflective elements and/or refractive elements (e.g., lenses)) of an RIS.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components of the network node 110c described above in connection with FIG. 1, such as a radio, one or more RF chains, one or more transceivers, or one or more modems, each of which may in turn be coupled with one or more antennas of the network node 110c described in connection with FIG. 1. In some aspects, the transmission component 904 may be associated with RIS elements (e.g., reflective elements and/or refractive elements (e.g., lenses)) of an RIS. In some aspects, the transmission component 904 may be co-located with the reception component 902.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The reception component 902 may receive, from a network node, configuration information to configure the RIS to apply a set of RIS patterns associated with one or more calibration codebooks during an RIS calibration procedure. The communication manager 906 may apply the set of RIS patterns during the RIS calibration procedure based at least in part on the configuration information. The reception component 902 may receive, from the network node, an indication of an updated data communication codebook, wherein the updated data communication codebook is based at least in part on one or more RSRP measurement reports associated with one or more pilot signals that are transmitted during the RIS calibration procedure and while the RIS is applying the set of RIS patterns associated with the one or more calibration codebooks.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a network node, comprising: transmitting, to a reconfigurable intelligent surface (RIS), configuration information to configure the RIS to apply a set of RIS patterns associated with one or more calibration codebooks during an RIS calibration procedure; receiving one or more reference signal received power (RSRP) measurement reports associated with one or more pilot signals that are transmitted during the RIS calibration procedure and while the RIS is applying the set of RIS patterns associated with the one or more calibration codebooks; and updating a data communication codebook based at least in part on the one or more RSRP measurement reports.

Aspect 2: The method of Aspect 1, wherein the set of RIS patterns associated with the one or more calibration codebooks is configured to enable estimation of phase-drift impairments of the RIS based at least in part on the one or more RSRP measurement reports.

Aspect 3: The method of any of Aspects 1-2, wherein the RIS is associated with multiple RIS elements, wherein the one or more calibration codebooks are associated with a grouping-based calibration codebook design, wherein the grouping-based calibration codebook design is associated with grouping the multiple RIS elements into multiple groups, and wherein, for each group, of the multiple groups, the respective RIS elements are configured with identical reflection coefficients.

Aspect 4: The method of any of Aspects 1-3, wherein the one or more calibration codebooks are associated with a dither-based calibration codebook design, and wherein the dither-based calibration codebook design is associated with a dither component used to introduce variability in reflected signal profiles.

Aspect 5: The method of any of Aspects 1-4, wherein the one or more pilot signals are transmitted, during the RIS calibration procedure, from a first buddy node to a second buddy node via the RIS, wherein the method further comprises identifying a bounding region associated with a location uncertainty of at least one of the first buddy node or the second buddy node, and wherein updating the data communication codebook is further based at least in part on the bounding region.

Aspect 6: The method of Aspect 5, wherein the bounding region is associated with one of a bounding cuboid or a bounding ellipsoid.

Aspect 7: The method of Aspect 5, further comprising receiving, from at least one of the first buddy node or the second buddy node, an indication of the bounding region.

Aspect 8: The method of any of Aspects 1-7, further comprising selecting the one or more calibration codebooks based at least in part on at least one of a mutual-information maximation approach or a mean-squared-error minimization approach.

Aspect 9: The method of any of Aspects 1-8, wherein the RIS calibration procedure is associated with multiple calibration sounding stages, wherein the configuration information configures the RIS to apply a first calibration codebook, of the one or more calibration codebooks, during a first calibration stage, of the multiple calibration sounding stages, and wherein the configuration information configures the RIS to apply a second calibration codebook, of the one or more calibration codebooks, during a second calibration stage, of the multiple calibration sounding stages.

Aspect 10: The method of Aspect 9, wherein the configuration information configures the RIS to apply the one or more calibration codebooks according to a calibration codebook sequence, and wherein the calibration codebook sequence is based at least in part on respective bounding boxes associated with one or more buddy nodes, respective locations of the one or more buddy nodes, or respective cascade channel estimates associated with the one or more buddy nodes.

Aspect 11: The method of any of Aspects 1-10, wherein the RIS calibration procedure is associated with multiple buddy node pairs, wherein the configuration information configures the RIS to apply a first calibration codebook, of the one or more calibration codebooks, during a first set of time-domain resources associated with transmission of a first pilot signal associated with a first buddy node pair, of the multiple buddy node pairs, and wherein the configuration information configures the RIS to apply a second calibration codebook, of the one or more calibration codebooks, during a second set of time-domain resources associated with transmission of a second pilot signal associated with a second buddy node pair, of the multiple buddy node pairs.

Aspect 12: The method of Aspect 11, further comprising: receiving, from a first buddy node associated with the first buddy node pair, an indication of a first maximum coherence span associated with the first buddy node; receiving, from a second buddy node associated with the first buddy node pair, an indication of a second maximum coherence span associated with the second buddy node; identifying a maximum coherence span associated with the first buddy node pair, wherein maximum coherence span associated with the first buddy node pair corresponds to a minimum of the first maximum coherence span and the second maximum coherence span; and selecting the first set of time-domain resources such that a duration of the first set of time-domain resources is less than or equal to the maximum coherence span associated with the first buddy node pair.

Aspect 13: The method of Aspect 11, further comprising: identifying a maximum frequency-domain coherence span associated with the first buddy node pair; and selecting a set of frequency-domain resources associated with the first set of time-domain resources such that a bandwidth associated with the set of frequency-domain resources is less than or equal to the maximum frequency-domain coherence span associated with the first buddy node pair.

Aspect 14: A method of wireless communication performed by a reconfigurable intelligent surface (RIS), comprising: receiving, from a network node, configuration information to configure the RIS to apply a set of RIS patterns associated with one or more calibration codebooks during an RIS calibration procedure; applying the set of RIS patterns during the RIS calibration procedure based at least in part on the configuration information; and receiving, from the network node, an indication of an updated data communication codebook, wherein the updated data communication codebook is based at least in part on one or more reference signal received power (RSRP) measurement reports associated with one or more pilot signals that are transmitted during the RIS calibration procedure and while the RIS is applying the set of RIS patterns associated with the one or more calibration codebooks.

Aspect 15: The method of Aspect 14, wherein the set of RIS patterns associated with the one or more calibration codebooks is configured to enable estimation of phase-drift impairments of the RIS based at least in part on the one or more RSRP measurement reports.

Aspect 16: The method of any of Aspects 14-15, wherein the RIS is associated with multiple RIS elements, wherein the one or more calibration codebooks are associated with a grouping-based calibration codebook design, wherein the grouping-based calibration codebook design is associated with grouping the multiple RIS elements into multiple groups, and wherein, for each group, of the multiple groups, the respective RIS elements are configured with identical reflection coefficients.

Aspect 17: The method of any of Aspects 14-16, wherein the one or more calibration codebooks are associated with a dither-based calibration codebook design, and wherein the dither-based calibration codebook design is associated with a dither component used to introduce variability in reflected signal profiles.

Aspect 18: The method of any of Aspects 14-17, wherein the one or more pilot signals are transmitted, during the RIS calibration procedure, from a first buddy node to a second buddy node via the RIS, and wherein the updated data communication codebook is further based at least in part on a bounding region associated with a location uncertainty of at least one of the first buddy node or the second buddy node.

Aspect 19: The method of Aspect 18, wherein the bounding region is associated with one of a bounding cuboid or a bounding ellipsoid.

Aspect 20: The method of any of Aspects 14-19, wherein the one or more calibration codebooks are selected based at least in part on at least one of a mutual-information maximation approach or a mean-squared-error minimization approach.

Aspect 21: The method of any of Aspects 14-20, wherein the RIS calibration procedure is associated with multiple calibration sounding stages, wherein applying the set of RIS patterns comprises: applying a first calibration codebook, of the one or more calibration codebooks, during a first calibration stage, of the multiple calibration sounding stages; and applying a second calibration codebook, of the one or more calibration codebooks, during a second calibration stage, of the multiple calibration sounding stages.

Aspect 22: The method of Aspect 21, wherein the configuration information configures the RIS to apply the one or more calibration codebooks according to a calibration codebook sequence, and wherein the calibration codebook sequence is based at least in part on respective bounding boxes associated with one or more buddy nodes, respective locations of the one or more buddy nodes, or respective cascade channel estimates associated with the one or more buddy nodes.

Aspect 23: The method of any of Aspects 14-22, wherein the RIS calibration procedure is associated with multiple buddy node pairs, and wherein the method further comprises: applying a first calibration codebook, of the one or more calibration codebooks, during a first set of time-domain resources associated with transmission of a first pilot signal associated with a first buddy node pair, of the multiple buddy node pairs; and applying a second calibration codebook, of the one or more calibration codebooks, during a second set of time-domain resources associated with transmission of a second pilot signal associated with a second buddy node pair, of the multiple buddy node pairs.

Aspect 24: The method of Aspect 23, wherein a first duration of the first set of time-domain resources is less than or equal to a first maximum coherence span associated with the first buddy node pair, and wherein a second duration of the second set of time-domain resources is less than or equal to a second maximum coherence span associated with the second buddy node pair.

Aspect 25: The method of Aspect 23, wherein a first bandwidth of a first set of frequency-domain resources associated with the first set of time-domain resources is less than or equal to a first maximum frequency-domain coherence span associated with the first buddy node pair, and wherein a second bandwidth of a second set of frequency-domain resources associated with the second set of time-domain resources is less than or equal to a second maximum frequency-domain coherence span associated with the second buddy node pair.

Aspect 26: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-25.

Aspect 27: An apparatus for wireless communication at a device, the apparatus comprising one or more memories and one or more processors coupled to the one or more memories, the one or more processors configured to cause the device to perform the method of one or more of Aspects 1-25.

Aspect 28: An apparatus for wireless communication, the apparatus comprising at least one means for performing the method of one or more of Aspects 1-25.

Aspect 29: A non-transitory computer-readable medium storing code for wireless communication, the code comprising instructions executable by one or more processors to perform the method of one or more of Aspects 1-25.

Aspect 30: A non-transitory computer-readable medium storing a set of instructions for wireless communication, the set of instructions comprising one or more instructions that, when executed by one or more processors of a device, cause the device to perform the method of one or more of Aspects 1-25.

Aspect 31: A device for wireless communication, the device comprising a processing system that includes one or more processors and one or more memories coupled with the one or more processors, the processing system configured to cause the device to perform the method of one or more of Aspects 1-25.

Aspect 32: An apparatus for wireless communication at a device, the apparatus comprising one or more memories and one or more processors coupled to the one or more memories, the one or more processors individually or collectively configured to cause the device to perform the method of one or more of Aspects 1-25.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A network node for wireless communication, comprising:
one or more memories; and
one or more processors, coupled to the one or more memories, the one or more processors individually or collectively configured to cause the network node to:
transmit, to a reconfigurable intelligent surface (RIS), configuration information to configure the RIS to apply a set of RIS patterns associated with one or more calibration codebooks during an RIS calibration procedure;
receive one or more reference signal received power (RSRP) measurement reports associated with one or more pilot signals that are transmitted during the RIS calibration procedure and while the RIS is applying the set of RIS patterns associated with the one or more calibration codebooks; and
update a data communication codebook based at least in part on the one or more RSRP measurement reports.

2. The network node of claim 1, wherein the set of RIS patterns associated with the one or more calibration codebooks is configured to enable estimation of phase-drift impairments of the RIS based at least in part on the one or more RSRP measurement reports.

3. The network node of claim 1, wherein the RIS is associated with multiple RIS elements,
wherein the one or more calibration codebooks are associated with a grouping-based calibration codebook design,
wherein the grouping-based calibration codebook design is associated with grouping the multiple RIS elements into multiple groups, and
wherein, for each group, of the multiple groups, the respective RIS elements are configured with identical reflection coefficients.

4. The network node of claim 1, wherein the one or more calibration codebooks are associated with a dither-based calibration codebook design, and
wherein the dither-based calibration codebook design is associated with a dither component used to introduce variability in reflected signal profiles.

5. The network node of claim 1, wherein the one or more pilot signals are transmitted, during the RIS calibration procedure, from a first buddy node to a second buddy node via the RIS,
wherein the one or more processors are further individually or collectively configured to cause the network node to identify a bounding region associated with a location uncertainty of at least one of the first buddy node or the second buddy node, and
wherein the one or more processors, to update the data communication codebook, are further individually or collectively configured to cause the network node to update the data communication codebook based at least in part on the bounding region.

6. The network node of claim 5, wherein the bounding region is associated with one of a bounding cuboid or a bounding ellipsoid.

7. The network node of claim 5, wherein the one or more processors are further individually or collectively configured to cause the network node to receive, from at least one of the first buddy node or the second buddy node, an indication of the bounding region.

8. The network node of claim 1, wherein the one or more processors are further individually or collectively configured to cause the network node to select the one or more calibration codebooks based at least in part on at least one of a mutual-information maximation approach or a mean-squared-error minimization approach.

9. The network node of claim 1, wherein the RIS calibration procedure is associated with multiple calibration sounding stages,
wherein the configuration information configures the RIS to apply a first calibration codebook, of the one or more calibration codebooks, during a first calibration stage, of the multiple calibration sounding stages, and
wherein the configuration information configures the RIS to apply a second calibration codebook, of the one or more calibration codebooks, during a second calibration stage, of the multiple calibration sounding stages.

10. The network node of claim 9, wherein the configuration information configures the RIS to apply the one or more calibration codebooks according to a calibration codebook sequence, and
wherein the calibration codebook sequence is based at least in part on respective bounding boxes associated with one or more buddy nodes, respective locations of the one or more buddy nodes, or respective cascade channel estimates associated with the one or more buddy nodes.

11. The network node of claim 1, wherein the RIS calibration procedure is associated with multiple buddy node pairs,
wherein the configuration information configures the RIS to apply a first calibration codebook, of the one or more calibration codebooks, during a first set of time-domain resources associated with transmission of a first pilot signal associated with a first buddy node pair, of the multiple buddy node pairs, and
wherein the configuration information configures the RIS to apply a second calibration codebook, of the one or more calibration codebooks, during a second set of time-domain resources associated with transmission of a second pilot signal associated with a second buddy node pair, of the multiple buddy node pairs.

12. The network node of claim 11, wherein the one or more processors are further individually or collectively configured to cause the network node to:
receive, from a first buddy node associated with the first buddy node pair, an indication of a first maximum coherence span associated with the first buddy node;
receive, from a second buddy node associated with the first buddy node pair, an indication of a second maximum coherence span associated with the second buddy node;
identify a maximum coherence span associated with the first buddy node pair, wherein maximum coherence span associated with the first buddy node pair corresponds to a minimum of the first maximum coherence span and the second maximum coherence span; and
select the first set of time-domain resources such that a duration of the first set of time-domain resources is less than or equal to the maximum coherence span associated with the first buddy node pair.

13. The network node of claim 11, wherein the one or more processors are further individually or collectively configured to cause the network node to:
identify a maximum frequency-domain coherence span associated with the first buddy node pair; and
select a set of frequency-domain resources associated with the first set of time-domain resources such that a bandwidth associated with the set of frequency-domain resources is less than or equal to the maximum frequency-domain coherence span associated with the first buddy node pair.

14. A reconfigurable intelligent surface (RIS) for wireless communication, comprising:
one or more memories; and
one or more processors, coupled to the one or more memories, the one or more processors individually or collectively configured to cause the RIS to:
receive, from a network node, configuration information to configure the RIS to apply a set of RIS patterns associated with one or more calibration codebooks during an RIS calibration procedure;
apply the set of RIS patterns during the RIS calibration procedure based at least in part on the configuration information; and
receive, from the network node, an indication of an updated data communication codebook, wherein the updated data communication codebook is based at least in part on one or more reference signal received power (RSRP) measurement reports associated with one or more pilot signals that are transmitted during the RIS calibration procedure and while the RIS is applying the set of RIS patterns associated with the one or more calibration codebooks.

15. The RIS of claim 14, wherein the set of RIS patterns associated with the one or more calibration codebooks is configured to enable estimation of phase-drift impairments of the RIS based at least in part on the one or more RSRP measurement reports.

16. The RIS of claim 14, wherein the RIS is associated with multiple RIS elements,
wherein the one or more calibration codebooks are associated with a grouping-based calibration codebook design,
wherein the grouping-based calibration codebook design is associated with grouping the multiple RIS elements into multiple groups, and
wherein, for each group, of the multiple groups, the respective RIS elements are configured with identical reflection coefficients.

17. The RIS of claim 14, wherein the one or more calibration codebooks are associated with a dither-based calibration codebook design, and
wherein the dither-based calibration codebook design is associated with a dither component used to introduce variability in reflected signal profiles.

18. The RIS of claim 14, wherein the one or more pilot signals are transmitted, during the RIS calibration procedure, from a first buddy node to a second buddy node via the RIS, and
wherein the updated data communication codebook is further based at least in part on a bounding region associated with a location uncertainty of at least one of the first buddy node or the second buddy node.

19. The RIS of claim 18, wherein the bounding region is associated with one of a bounding cuboid or a bounding ellipsoid.

20. The RIS of claim 14, wherein the one or more calibration codebooks are selected based at least in part on at least one of a mutual-information maximation approach or a mean-squared-error minimization approach.

21. The RIS of claim 14, wherein the RIS calibration procedure is associated with multiple calibration sounding stages,
wherein the one or more processors, to cause the RIS to apply the set of RIS patterns, are individually or collectively configured to cause the RIS to:
apply a first calibration codebook, of the one or more calibration codebooks, during a first calibration stage, of the multiple calibration sounding stages; and
apply a second calibration codebook, of the one or more calibration codebooks, during a second calibration stage, of the multiple calibration sounding stages.

22. The RIS of claim 21, wherein the configuration information configures the RIS to apply the one or more calibration codebooks according to a calibration codebook sequence, and
wherein the calibration codebook sequence is based at least in part on respective bounding boxes associated with one or more buddy nodes, respective locations of the one or more buddy nodes, or respective cascade channel estimates associated with the one or more buddy nodes.

23. The RIS of claim 14, wherein the RIS calibration procedure is associated with multiple buddy node pairs, and
wherein the one or more processors are further individually or collectively configured to cause the network node to:
apply a first calibration codebook, of the one or more calibration codebooks, during a first set of time-domain resources associated with transmission of a first pilot signal associated with a first buddy node pair, of the multiple buddy node pairs; and
apply a second calibration codebook, of the one or more calibration codebooks, during a second set of time-domain resources associated with transmission of a second pilot signal associated with a second buddy node pair, of the multiple buddy node pairs.

24. The RIS of claim 23, wherein a first duration of the first set of time-domain resources is less than or equal to a first maximum coherence span associated with the first buddy node pair, and
wherein a second duration of the second set of time-domain resources is less than or equal to a second maximum coherence span associated with the second buddy node pair.

25. The RIS of claim 23, wherein a first bandwidth of a first set of frequency-domain resources associated with the first set of time-domain resources is less than or equal to a first maximum frequency-domain coherence span associated with the first buddy node pair, and
wherein a second bandwidth of a second set of frequency-domain resources associated with the second set of time-domain resources is less than or equal to a second maximum frequency-domain coherence span associated with the second buddy node pair.

26. A method of wireless communication performed by a network node, comprising:
transmitting, to a reconfigurable intelligent surface (RIS), configuration information to configure the RIS to apply a set of RIS patterns associated with one or more calibration codebooks during an RIS calibration procedure;
receiving one or more reference signal received power (RSRP) measurement reports associated with one or more pilot signals that are transmitted during the RIS calibration procedure and while the RIS is applying the set of RIS patterns associated with the one or more calibration codebooks; and
updating a data communication codebook based at least in part on the one or more RSRP measurement reports.

27. The method of claim 26, wherein the RIS is associated with multiple RIS elements,
wherein the one or more calibration codebooks are associated with a grouping-based calibration codebook design,
wherein the grouping-based calibration codebook design is associated with grouping the multiple RIS elements into multiple groups, and
wherein, for each group, of the multiple groups, the respective RIS elements are configured with identical reflection coefficients.

28. The method of claim 26, wherein the one or more calibration codebooks are associated with a dither-based calibration codebook design, and
wherein the dither-based calibration codebook design is associated with a dither component used to introduce variability in reflected signal profiles.

29. A method of wireless communication performed by a reconfigurable intelligent surface (RIS), comprising:
receiving, from a network node, configuration information to configure the RIS to apply a set of RIS patterns associated with one or more calibration codebooks during an RIS calibration procedure;
applying the set of RIS patterns during the RIS calibration procedure based at least in part on the configuration information; and
receiving, from the network node, an indication of an updated data communication codebook, wherein the updated data communication codebook is based at least in part on one or more reference signal received power (RSRP) measurement reports associated with one or more pilot signals that are transmitted during the RIS calibration procedure and while the RIS is applying the set of RIS patterns associated with the one or more calibration codebooks.

30. The method of claim 29, wherein the RIS calibration procedure is associated with multiple calibration sounding stages,
wherein applying the set of RIS patterns comprises:
applying a first calibration codebook, of the one or more calibration codebooks, during a first calibration stage, of the multiple calibration sounding stages; and
applying a second calibration codebook, of the one or more calibration codebooks, during a second calibration stage, of the multiple calibration sounding stages.
